(19) United States
(12) Patent Application Publication
(10) Pub. No.: US 2004/0024636 A1
(43) Pub. Date: Feb. 5, 2004

(54) System and method of designating content for presentation to a target entity

(75) Inventors: Jay M. Jaffe, North Bethesda, MD (US); Sharon Smith Leaman, Fredericksburg, VA (US); Donna L. Smith, Fredericksburg, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Jaffe Associates, Inc., Bethesda, MD (US)

(21) Appl. No.: 10/207,978

(22) Filed: Jul. 31, 2002

(51) Int. Cl. G06F 17/60; G06F 17/30

(52) U.S. Cl. 705/14; 707/9

(57) ABSTRACT

A computer-based system and associated method is provided for designating content for presentation to a target entity. The system includes a mechanism for prompting a user to input identification indicia associated with the user. The identification indicia corresponds to an access level. The user is granted user access to the content at the access level in response to the identification indicia input by the user. A marketing interface is provided to the user for selecting content options in accordance with the access level. The user designates content responsive to the needs of the target entity by selecting the content options of the marketing interface. The user is provided with options for formatting the designated content through the marketing interface. The content is produced for presentation to the target entity in a desired manner and through a desired form.

### BACKGROUND OF THE INVENTION

The present invention relates, generally, to a system and method of presenting selected materials of a collection of materials as target based content. More particularly, the present invention provides an electronic system for tailoring content such as sales/informative documentation in accordance with a perceived need/interest of a target entity relative to the capabilities/products of an organization.

### DISCUSSION OF THE BACKGROUND

The long term success of an organization is rooted, in large part, in an organization's ability to effectively communicate with a desired audience/market. In the commercial context, information distribution is the means by which an organization communicates or “markets” its goals, services, products and associated promotional materials. The modem commercial marketplace embraces organizations which are capable of dynamically adapting to the varying needs of individual consumers and consumer markets.

With this object in mind, commercial organizations seek to provide marketing information pertaining to their services, products and capabilities to potential customers, suppliers, or other interested parties. In some situations, it can be sufficient to convey the written marketing information in the form of print media such as an advertisement in a magazine, newspaper, or other periodical. This information distribution scheme is particularly well suited for markets consuming high volumes of products or services, as these markets are not necessarily tailored for a particular consumer or a specific market application. For example, all of the readers or “targets” of print media receive the same information. However, when the target audience is much smaller, of diversified interest, and the potential revenue at stake is substantial, it is generally more effective to tailor the advertisement to individual target entities of the audience.

Target based marketing information, or content which is tailored for a specific market or consumer (i.e., target entity), is a fundamental component of organizations which serve a distinct commercial market. Target based marketing information is utilized by both suppliers and consumers for facilitating commercial relations. For example, when a commercial contractor (i.e., supplier) is planning to respond to a Request For Proposal (RFP) for a large government (i.e., consumer) procurement contract, the contractor prepares one or more carefully written proposal volumes describing the type of systems and/or services which satisfy the requirements of the RFP. Typically, the written proposal is labor intensive and is prepared by a staff of marketing procurement specialists to tout the capabilities of the contracting organization.

Similarly, when representatives of a supplier organization initially contact an individual or consumer company, it is often useful to distribute marketing materials touting the benefits and capabilities of the supplier organization in a manner which is specifically directed to the needs of the individual or consumer company. For example, where a target entity is active in one of several niche markets served by a supplier, the entity is likely not interested in all of the niche markets served by the supplier, but only the market pertaining to the target entities commercial activities. Yet, the preparation of multiple target based marketing materials, each tailored to the specific interest of a target entity, tend to be costly and time consuming, often requiring a highly specialized staff of skilled personnel to produce such target based information in advance.

As such, a dynamic system and method of designating content for presentation to a target entity is desired which is devoid of the aforementioned limitations.

### SUMMARY OF THE INVENTION

A system is provided for efficiently and effectively producing target based content, while maintaining the security of proprietary content through a hierarchical access scheme. The present invention conveniently decentralizes the responsibility for designating content for presentation, while centralizing the depository for populating a content database. The format and substance of target based content is tailored to suit a target entity by an adaptive content designation process. The system and associated method produces target based content for presentation in a cost effective manner as it conserves resources involving advanced printing of multiple content versions. Further, the invention allows security management for controlling access to sensitive content and tracks the creation and distribution of content materials.

In accordance with an aspect of the present invention, a method of designating content for presentation to a target entity is provided. The method includes prompting a user to input lo identification indicia associated with the user. The identification indicia corresponds to an access level. The user is granted access at the access level corresponding to the identification indicia input by the user. A marketing interface is provided to the user for selecting content options in accordance with the access level. The user designates content responsive to the needs of the target entity by selecting the content options of the marketing interface. The user is provided with options for formatting and editing the designated content through the marketing interface at the appropriate access level. The content is produced for presentation to the target entity in a desired manner and through a desired form.

In another aspect of the invention, an electronic system for designating content for presentation to a target entity is provided. The system includes memory that stores the collection of content and a mechanism prompting a user to input identification indicia associated with the user, the identification indicia corresponding to an access level. The user is then granted access at an access level in response to the identification indicia input by the user. An interface enables the selection of content options in accordance with the access level to designate the selected materials responsive to the needs of the target entity by selecting the content options of the marketing interface and for providing the user with options for formatting the selected materials. An output device produces the selected materials of the collection of content for presentation to the target entity.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings wherein:

FIG. 1 is a high level block diagram of the system of designating content for presentation to a target entity in accordance with the present invention;

FIG. 2 illustrates a block diagram of an exemplary system upon which embodiments of the present invention may be implemented;

FIG. 3 is a flow chart illustrating the operation of designating selected materials of a collection of content for presentation to a target entity in accordance with the present invention;

FIG. 4a is an exemplary template for receiving user indicia data fields in accordance with the flow chart of FIG. 3;

FIG. 4b is an exemplary interface for accessing administrative functionality of the system;

FIG. 4c is an exemplary interface for updating users and corresponding access levels of the system;

FIG. 5a is a sample screen display listing available content creation options in accordance with the flow chart of FIG. 3;

FIG. 5b is a sample screen display listing available content previously designated and saved into selected materials by a particular user in accordance with the flow chart of FIG. 3;

FIG. 5c is a sample screen display listing available content previously designated as a favorite and saved into selected materials by a particular user in accordance with the flow chart of FIG. 3;

FIG. 5d is a sample screen display listing available content previously designated as a favorite and saved into selected materials by a particular group in accordance with the flow chart of FIG. 3;

FIG. 5e is a sample screen display listing available content previously designated as a favorite into selected materials by a particular organization in accordance with the flow chart of FIG. 3;

FIG. 5f is a sample screen display listing all available content previously designated into selected materials in accordance with the flow chart of FIG. 3;

FIG. 5g is a sample screen display listing available output options in accordance with the flow chart of FIG. 3;

FIG. 6 is an exemplary template for receiving data fields for identifying tracking data in accordance with the flow chart of FIG. 3;

FIG. 6a is an exemplary interface for querying tracking data in accordance with the flow chart of FIG. 3;

FIG. 6b is an exemplary output report produced by the query of FIG. 6a;

FIG. 7 is an exemplary interface for designated selected materials of a collection of content in accordance with the flow chart of FIG. 3;

FIG. 8 is an exemplary interface for designating niche markets in accordance with the flow chart of FIG. 3;

FIG. 9a is an exemplary sub-menu interface for designating component data pertaining to a selected niche market in accordance with the flow chart of FIG. 3;

FIG. 9b is an exemplary interface for reviewing entered data so that it can be revised if necessary in accordance with the flow chart of FIG. 3;

FIG. 9c is an exemplary interface for importing content to the system;

FIG. 9d is an exemplary interface for importing niche market content to the system;

FIG. 9e is an exemplary interface for deleting and updating content of the system;

FIG. 9f is an exemplary template for updating content in accordance with FIG. 9e;

FIG. 9g is an exemplary interface for classifying content;

FIG. 9h is an exemplary interface for associating content with niche market categories;

FIG. 9i is an exemplary interface for revising the associates content of FIG. 9h;

FIG. 9j is an exemplary interface for associating content with organization categories;

FIG. 9k is an exemplary interface for defining purposes of the designation of the selected content; and

FIG. 10 is an exemplary interface for formatting the selected materials into a desired presentation type in accordance with the flow chart of FIG. 3.

### DETAILED DESCRIPTION OF THE INVENTION

Certain terminology used in the following description is for convenience only and is not limiting. The term “target entity” as used herein refers to both individuals and/or organizations, the term is not limited to commercial participants, but is equally applicable to non-profit organizations and private parties. The term “click” as used herein refers to the usual manner of selecting and accessing textual and graphical based computer information. The term does not limit the present invention to mouse-based peripherals or like interface devices, but is simply utilized as a shorthand term for describing known computer functionality and processes. The term “content” as used herein refers to text based, image based and audio materials which are designated for presentation to a target entity for presentation, the materials may be presented in electronic (i.e., E-form) and/or “hard copy” format (i.e., tangible form) where appropriate. In the drawings, the same reference numerals are used for designating the same elements throughout the several figures.

The present invention, as disclosed in the foregoing exemplary embodiment provides a system and associated method of designating selected materials of a collection of content for presentation to a target entity. The system decentralizes the content creation function so that content can be dynamically designated and edited for presentation by a group of users, across pre-defined access levels from a plurality of locations, while centralizing the depository of the content database. The method includes prompting a user to input identification indicia associated with the user. The identification indicia corresponds to an access level. The user is granted access at the access level in response to the identification indicia input by the user. A marketing interface is provided to the user for selecting content options in accordance with the access level. The user designates content responsive to the needs of the target entity by selecting the content options of the marketing interface. The user is provided with options for formatting, updating and editing the designated content through the marketing interface. The designated content is produced for presentation to the target entity in a desired manner and through a desired form. Thus, the format and substance of target based content can be readily tailored to suit a target entity, in an efficient and cost effective manner.

Regarding the user access capabilities, it is noted that organizations often find it advantageous, or even necessary, to restrict their employee's access to certain company information, e.g., internal marketing data and company proprietary information. For example, it is often desirable that user access be limited to sensitive information or the ability to change certain information (e.g., cost or pricing information, editing capabilities) be selectively granted. Likewise information for designated selected materials of a collection of content may be limited in other manners. For example, organizational data access restrictions, functional data access restrictions, or other like types of data access restrictions may be implemented. In an organizational data access restriction, the members of one division or “niche market” of a company may not be able to access information for creating content if that information pertains only to another niche market within the company such as another division. In the exemplary embodiment of the present invention, some information would be available to all organizations within a company, while other types of information may be made available on an organization-specific basis. Similarly, the access a user has to content may be limited by the user's function within the company. For example, the marketing personnel may have different information available to their disposal for use in designating content than would the staff in the research and development department or the personnel staff.

I. System Components

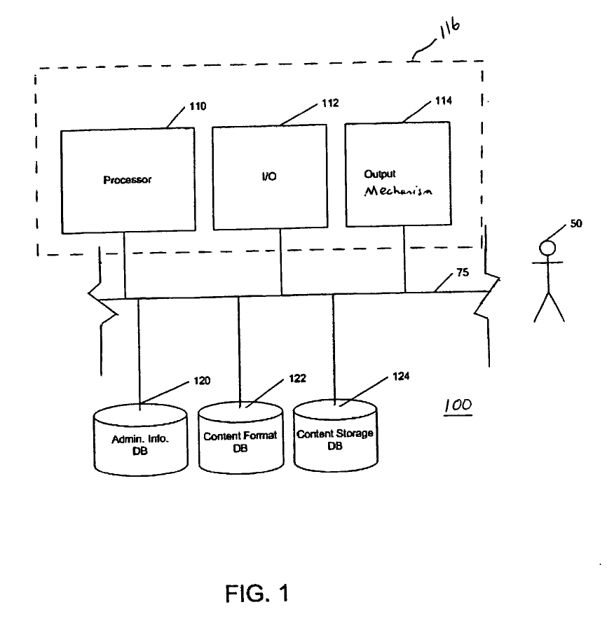

Referring now to the figures, FIG. 1 is a high level block diagram of a system 100 for designating selected materials of a collection of content for presentation to a target entity 50 in accordance with the present invention. The exemplary system 100 includes a computer system 116 having, an input/output (I/O) interface 112, an output mechanism (such as a printer) 114 and a processor 110. The exemplary computer system 116 is operably linked to an administrative information database 120 (DB), a content formatting database 122, and a content storage database 124 via a network 75.

The network of the exemplary embodiment is a local area network (LAN) such as an intranet. Of course, those skilled in the art will recognize that network 75 may be a wide area network (WAN) such as the Internet. Similarly, the network 75 is not limited to hard wired technology but may be formed of any known technology for communicating data such as wireless and/or optical communication networks.

The exemplary embodiment provides several databases, e.g., administrative information database 120, a content formatting database 122, and content storage database 124 operably linked to one another and the computer system 116 via the network 75. In accordance with different embodiments of the present invention, the databases 120-124 can each be contained within a different memory or storage device, although these databases need not be separated into different memories or storage devices. These databases may be part of a single computer memory or any type of storage media capable of storing data or other information. Moreover, a single database may be provided for performing the functionality of databases 120-124 shown here separately for purposes of explaining their functionality.

The exemplary administrative information database 120 includes a database management instruction set for cooperating with an instruction set of computer system 116 or other application software which controls steps for practicing the present invention. The database 120 also includes user indicia such as user names, passwords associated with the user names, and various corresponding levels of access permitted to the different users based upon the corresponding user indicia. In the exemplary embodiment, the database management software utilized for databases 120-124 is MS Access®, SYBASE (or the like) which serves as the database engine and data repository, and Cold Fusion®, HTML, PHP, ASP (or the like) software as the query and call intermediary.

The content formatting database 122 includes data used to assemble and produce a desired content format such as a marketing brochure. For example, the content formatting database 122 includes fonts, text protocols, word processing scripts, image generation programs, and other logic for working with image data and text data which may go into a marketing content via the brochure formatting database 124.

The content storage database 124 stores copies of marketing brochures which have been created previously, or are in various stages of completion and correlates them to a particular user. The content storage database 124 allows a user to conveniently pull up a previously created version and make some alterations and/or complete an unfinished brochure in accordance with their access level. Thus it is not typically necessary to re-create a previously created marketing brochure.

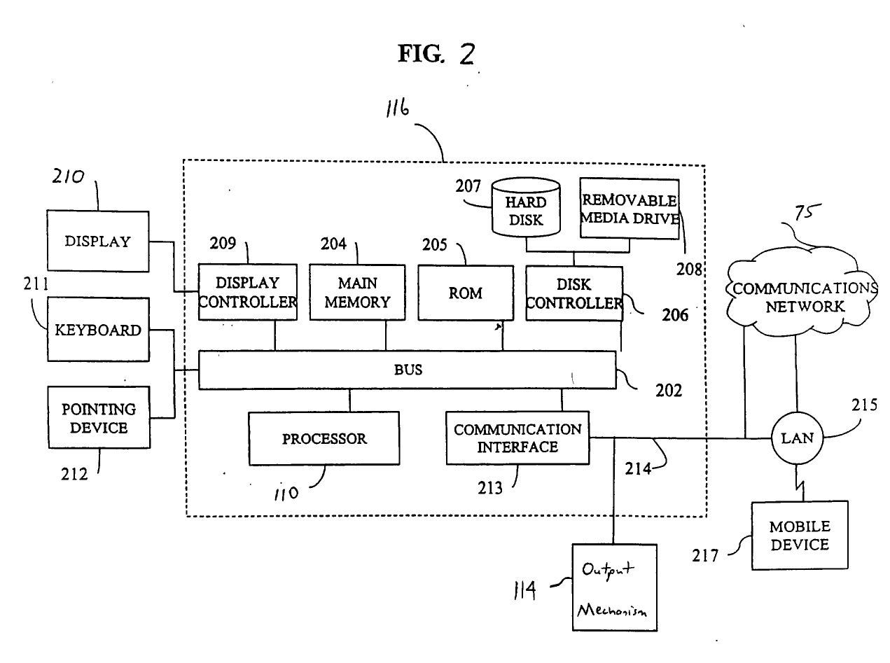

The components of the computer system 116 of the exemplary embodiment are embodied in a suitable personal computer (PC) as shown in FIG. 2, however those skilled in the art will recognize that the computing function of computer system 116 may be performed by a plurality of known computing devices, such as a personal digital assistant (PDA) or laptop computer, similarly, the individual functions of the computer could be spread across several machines as a distributed computing process.

The exemplary computer system 116 is a stand-alone configuration and employs a processor 110 having an instruction set for functioning to exchange control and data information with the components of system 100 as indicated by the solid lines shown connecting the components. Of course, dedicated logic circuitry, or any other sort of computer or computing device capable of carrying out pre-stored instructions may be provided to perform the processing functionality described herein. In the exemplary embodiment, an application program is provided for managing and implementing the functionality of the present invention.

The I/O interface 112 of computer system 116 is provided for communicating with various peripheral components of the computer system 116 as shown in more detail in FIG. 2 together with databases 120, 122 and 124. The exemplary I/O interface 112 may be a port for connecting the computer system 110 to the intranet or other network, or a telephone line, or any other interface circuitry for operably linking the system 100 to additional equipment.

The output mechanism 114 of the exemplary embodiment is a printer such as a dedicated printer connected to the computer system 110, or it may be a printer linked via network 75, through which the computer system 110 can send print jobs to the printer 114. Further, while the content is discussed herein as being presented as a printed material, those skilled in the art will recognize that the presentation format is equally applicable to both electronic and tangible presentation materials. For example, in alternative embodiments, the output mechanism 114 may be an audio visual display such as an NTSC video monitor for providing audio video presentation of content to the target entity 50. Moreover, the output mechanism 114 may be a telecommunication path to network 75 for delivering content in electronic form. For example, where the target entity is geographically remote, the delivery of the target based content is usually put in an electronic format such as portable document format (PDF). Remote delivery can also be provided via POWERPOINT® slideshow, or one of a plurality of known audio/video formats such as MPEG-x, MJPEG, DV, Quicktime™ or RealVideo™ for video conferencing, likewise these formats can be encoded on a suitable magnetic medium (i.e., tangible format) to decrease shipping costs or to free-up bandwidth of the enterprise network 75.

In the exemplary embodiment, the system 100 functions to designate and assemble selected materials of a collection of content for presentation. The presented materials are provided as a format type, such as a marketing brochures. While the exemplary embodiment describes a single format of content, namely a “marketing brochure,” those skilled in the art will recognize that this is but one of a plurality of format types, such types including the following illustrative examples: prospectus, application, catalog, portfolio and the like.

In an alternative embodiment, the processing function of computer system 116 may be implemented in a network configuration. In this embodiment, the processing function of computer system 116 is performed by a server computer for interfacing with one or more suitably equipped network terminals (not shown) and databases 120, 122 and 124. In this embodiment, the computer system 116 would execute a commercial server application such as available from Sun Microsystems® as the interface to the network 75 for facilitating communication through hypertext transfer protocol for interactive viewing at an operably linked terminal employing a graphical user interface (GUI) (not shown). In this way, a World Wide Web and FTP front-end may be embodied by computer system 116. Static web pages may comprise the structural portion of the viewable website, including query templates, resultant data pages, site navigation features, and supporting information. Of course, the network terminals would require suitable web browsing software for accessing the web content such as Microsoft Explorer®.

Referring now more specifically to FIG. 2, a block diagram of the computer system 116 is shown upon which the exemplary embodiment of the present invention is implemented. The computer system 116 is a PC, such as a Pentium™ class utilizing an operating system for driving a GUI such as that based on Microsoft Windows®, of course those skilled in the art will recognize that alternative operating systems such as UNIX, LINUX, MAC-OS, etc. are equally applicable to the teachings of the invention.

The exemplary computer system 116 includes a bus 202 or other communication mechanism for communicating information, and a processor 110 coupled with the bus 202 for processing the information. The computer system 116 also includes a main memory 204, such as a random access memory (RAM) or other dynamic storage device (e.g., dynamic RAM (DRAM), static RAM (SRAM), and synchronous DRAM (SDRAM)), coupled to the bus 202 for storing information and instructions to be executed by processor 110. In addition, the main memory 204 may be used for storing temporary variables or other intermediate information during the execution of instructions by the processor 110. The computer system 116 further includes a read only memory (ROM) 205 or other static storage device (e.g., programmable ROM (PROM), erasable PROM (EPROM), and electrically erasable PROM (EEPROM)) coupled to the bus 202 for storing static information and instructions for the processor 110. In the exemplary embodiment, memory 205 houses databases 120-124.

The computer system 116 also includes a disk controller 206 coupled to the bus 202 to control one or more storage devices for storing information and instructions, such as a magnetic hard disk 207, and a removable media drive 208 (e.g., floppy disk drive, read-only compact disc drive, read/write compact disc drive, compact disc jukebox, tape drive, and removable magneto-optical drive) or an optical medium, a carrier wave (described below), or any other medium from which a computer can read. The functionality of databases 120-124 may be performed by any combination of such devices and technologies. The storage devices may be added to the computer system 116 using an appropriate device interface (e.g., small computer system interface (SCSI), integrated device electronics (IDE), enhanced-IDE (E-IDE), direct memory access (DMA), or ultra-DMA).

The computer system 116 may also include a display controller 209 coupled to the bus 202 to control a display 210, such as a cathode ray tube (CRT), for displaying information to a user of the system. For example, the various content options relating to the present invention may be shown as a menu on the display 114 through which the user makes choices using a graphical user interface by simply clicking on the desired selections. The computer system includes input devices, such as a keyboard 211 and a pointing device 212, for interacting with a computer user and providing information to the processor 110 through I/O means 112. The pointing device 212, for example, may be a mouse, a trackball, touchscreen or a pointing stick for communicating direction information and command selections to the processor 110 and for controlling cursor movement on the display 114. In addition, a printer may provide as the output mechanism 114 to print content stored and/or generated by the computer system 116.

The computer system 116 performs a portion or all of the processing steps of the invention in response to the processor 110 executing one or more sequences of one or more instructions contained in a memory, such as the main memory 204. Such instructions may be read into the main memory 204 from another computer readable medium, such as a hard disk 207 or a removable media drive 208. In alternative embodiments, hard-wired circuitry may be used in place of or in combination with software instructions. Thus, embodiments are not limited to any specific combination of hardware circuitry and software described herein.

Stored on any one or on a combination of computer readable media, the present invention includes software for controlling the computer system 116, for driving a device or devices for implementing the invention, and for enabling the computer system 116 to interact with a user (e.g., content production personnel). Such software may include, but is not limited to, device drivers, operating systems, development tools, and application software.

The computer code/instruction set devices of the present invention may be any interpretable or executable code mechanism, including but not limited to scripts, interpretable programs, dynamic link libraries (DLLs), Java classes, machine language, assembly code and any executable software program. Moreover, parts of the processing of the present invention may be distributed for better performance, reliability, and/or cost.

The computer system 116 also includes a communication interface 213 as part of I/O means 112 coupled to the bus 202. The communication interface 213 provides a two-way data communication coupling to a network link 214 that is connected to, for example, a local area network (LAN) 215, or to another communications network 75 such as the Internet. For example, the communication interface 213 may be a network interface card to attach to any packet switched LAN. As another example, the communication interface 213 may be an asymmetrical digital subscriber line (ADSL) card, an integrated services digital network (ISDN) card or a modem to provide a data communication connection to a corresponding type of communications line; Wireless links may also be implemented. In any such implementation, the communication interface 213 sends and receives electrical, electromagnetic or optical signals that carry digital data streams representing various types of information.

The network link 214 typically provides data communication through one or more networks to other data devices. For example, the network link 214 may provide a connection to another computer through a local network 215 (e.g., a LAN) or through equipment operated by a service provider, which provides communication services through a communications network 75. The local network 214 and the communications network 75 use, for example, electrical, electromagnetic, or optical signals that carry digital data streams, and the associated physical layer (e.g., CAT 5 cable, coaxial cable, optical fiber, etc). The signals through the various networks and the signals on the network link 214 and through the communication interface 213, which carry the digital data to and from the computer system 116 maybe implemented in baseband signals, or carrier wave based signals. The baseband signals convey the digital data as umnodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 116 can transmit and receive data, including program code, through the network(s) 215 and 75, the network link 214 and the communication interface 213. Moreover, the network link 214 may provide a connection through a LAN 215 to a mobile device 217 such as a personal digital assistant (PDA) laptop computer, or cellular telephone.

II. System Methodology

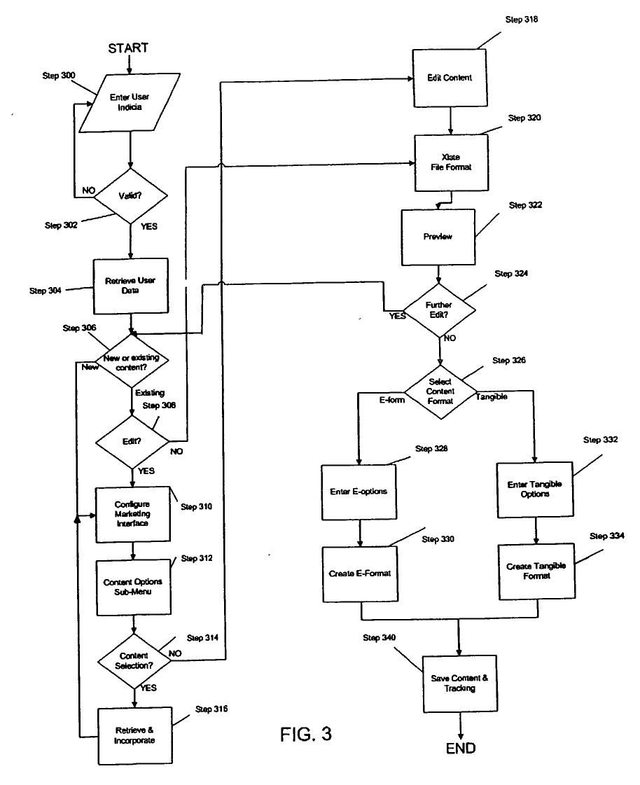

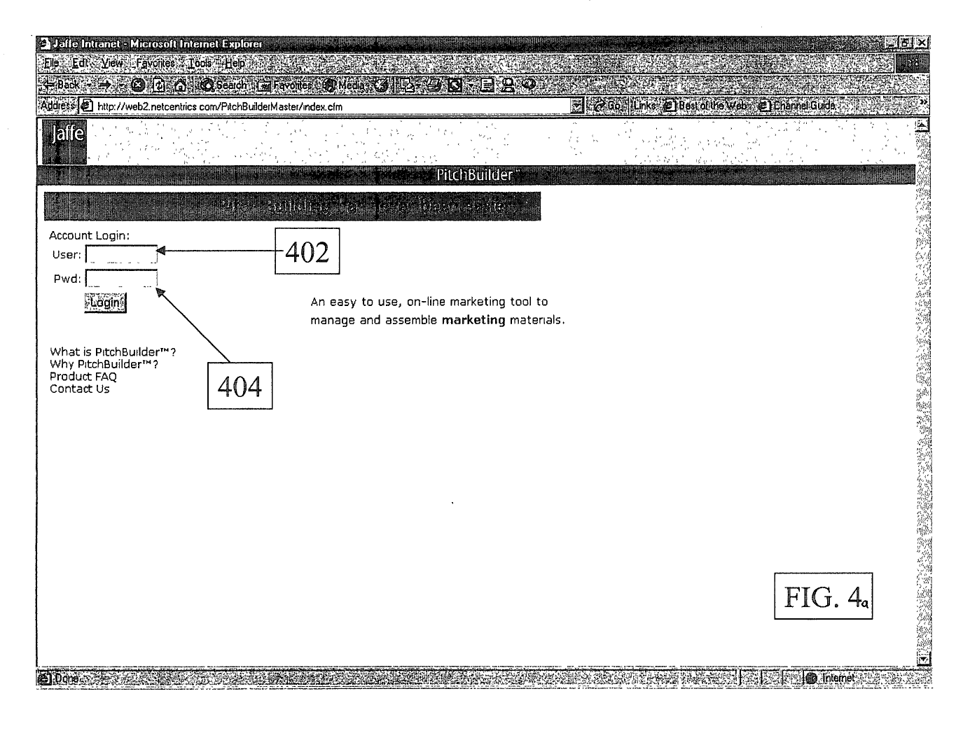

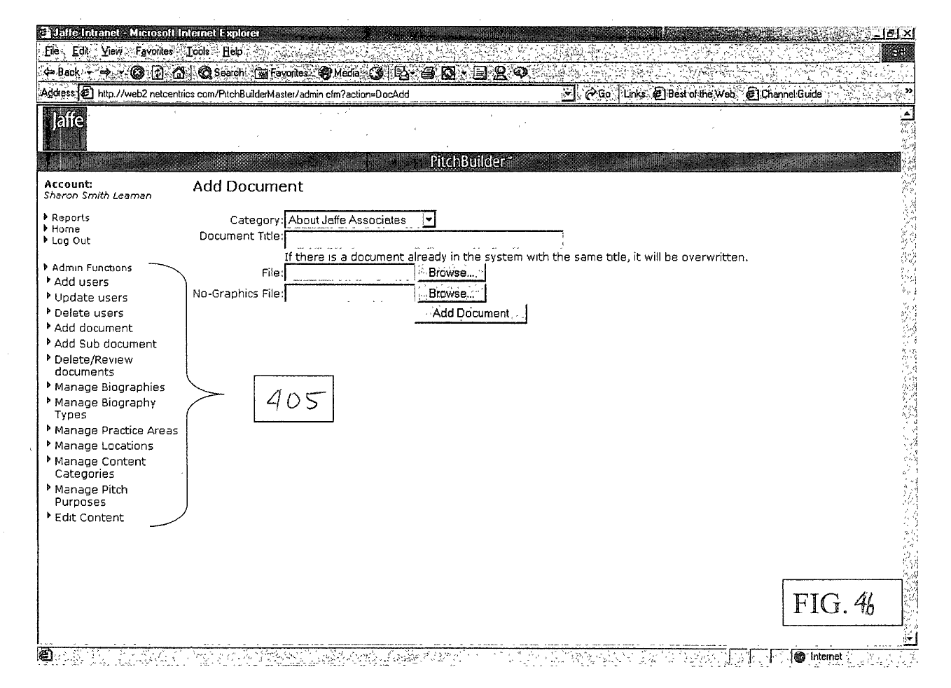

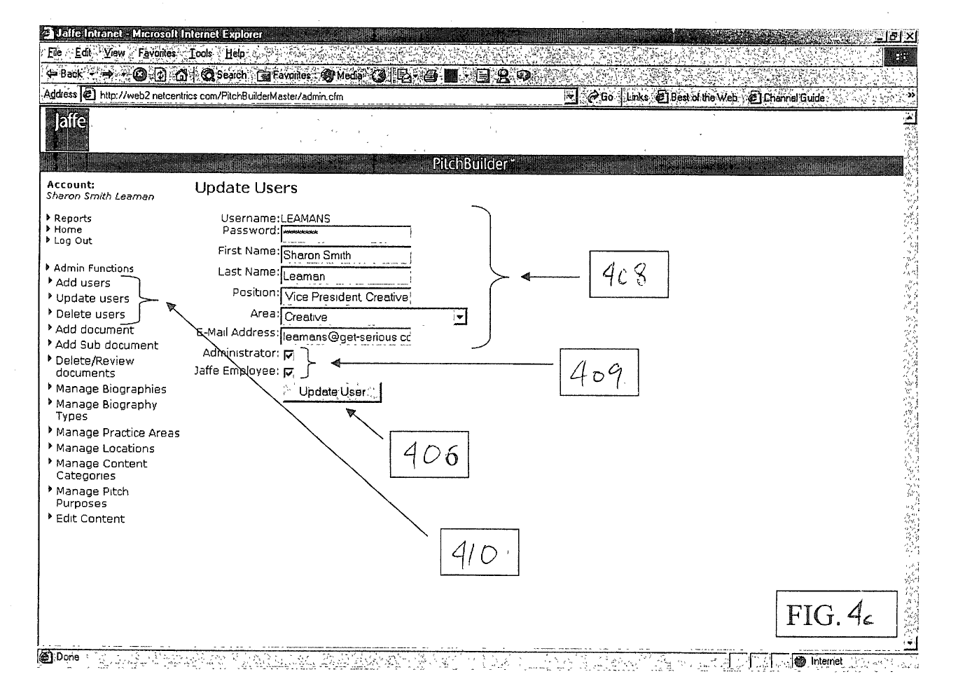

Referring now to FIG. 3, a flow chart is shown for explaining the designation of selected materials of a collection of content for presentation to a target entity in accordance with the present invention. FIG. 3 will be best understood when read in conjunction with FIGS. 4-12 which show exemplary screen displays and interfaces of the system 100. The screen displays and interfaces of the exemplary embodiment are provided to the user via a GUI, the displays of the exemplary embodiment are preferably created by a browser based programming language such as Cold Fusion, HTML, Java, Active X, ASP, PHP or like.

In the alternative embodiment, where the computer 116 is a web server and the user is operating a network terminal, queries are passed to the server from the network terminal as Asynchronous Common Gateway Interface (ACGI) Events. The server then retrieves relevant data, formats into the appropriate presentation language (e.g., PDF or HTML) and provides the data to the user via the network terminal.

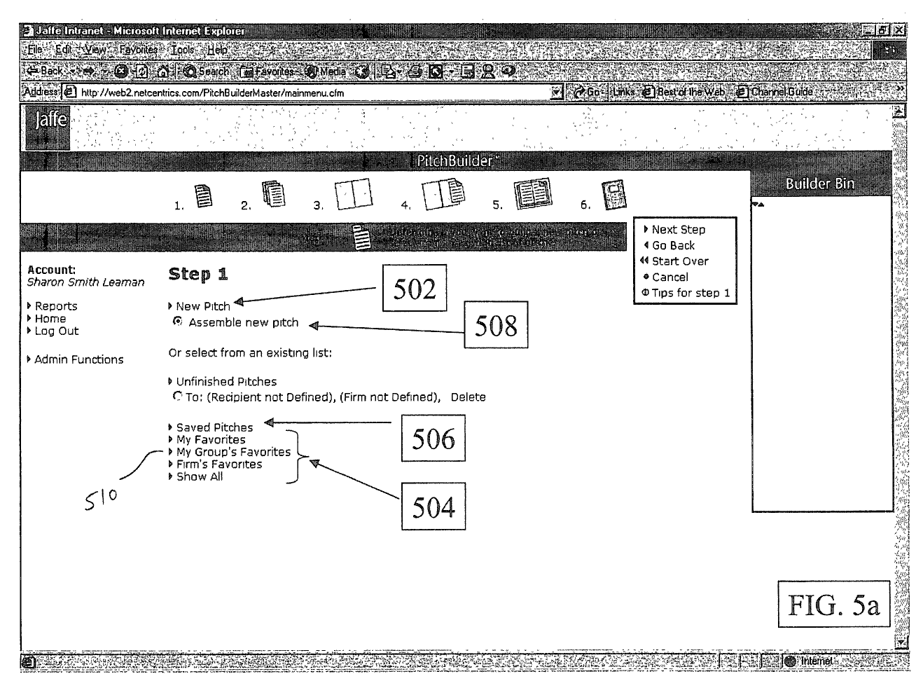

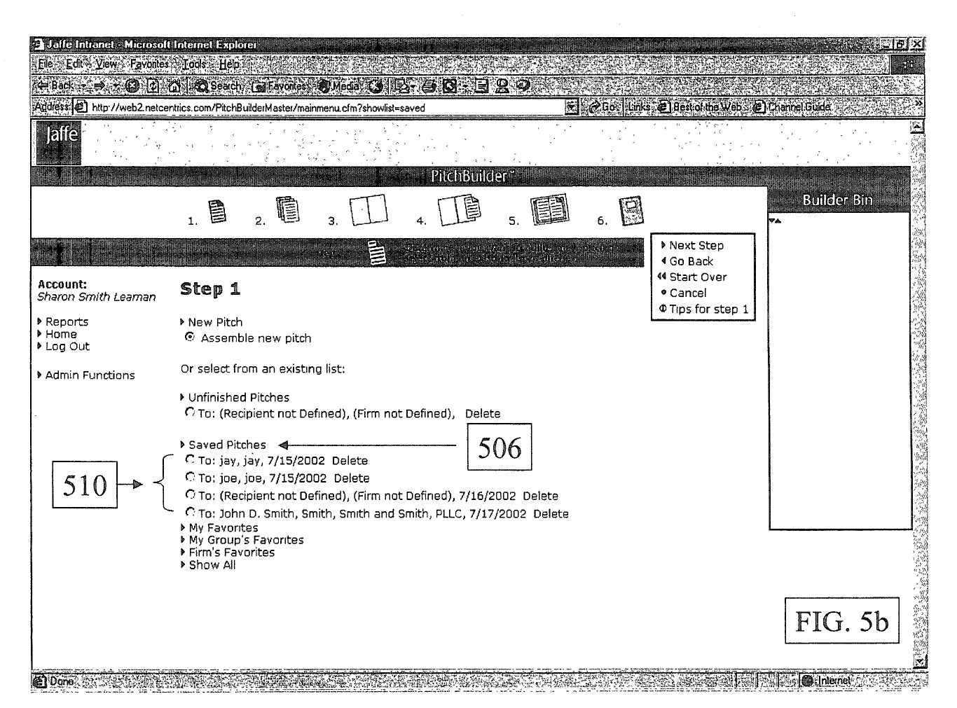

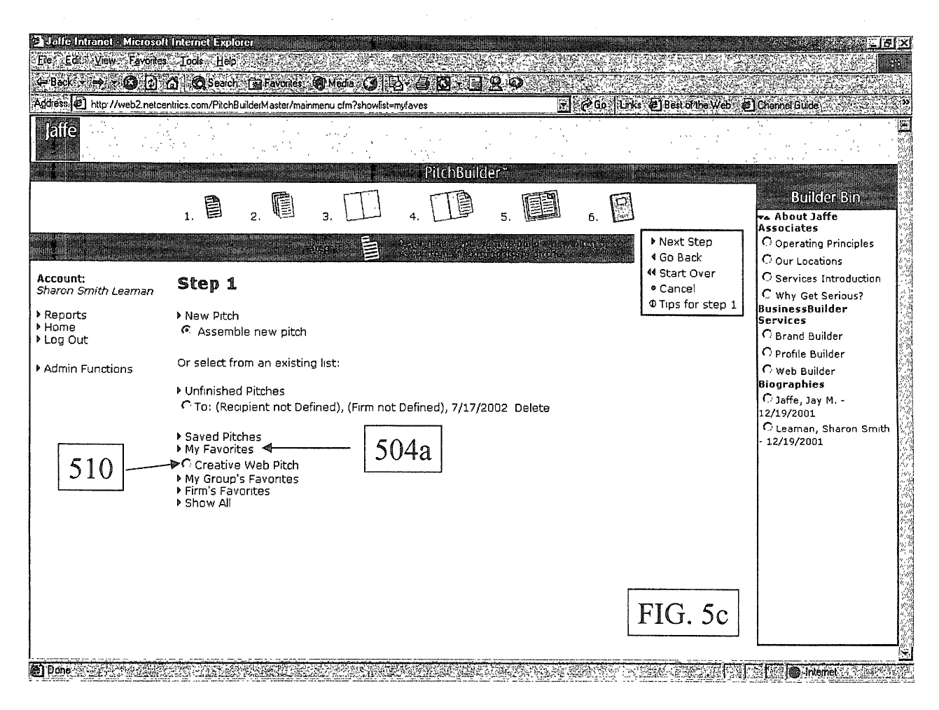

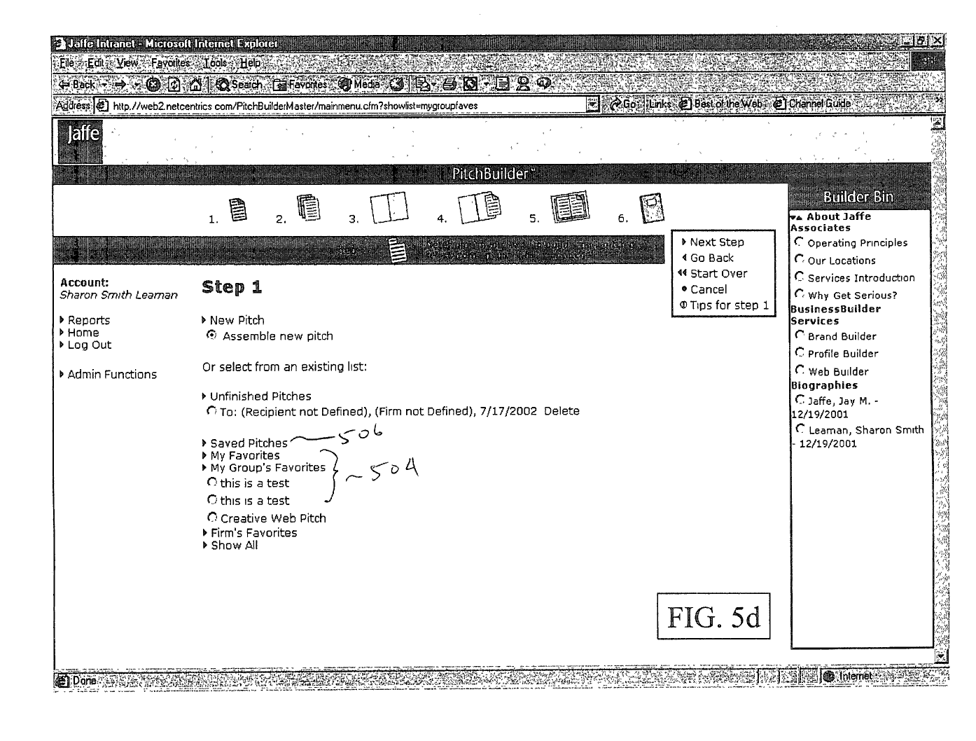

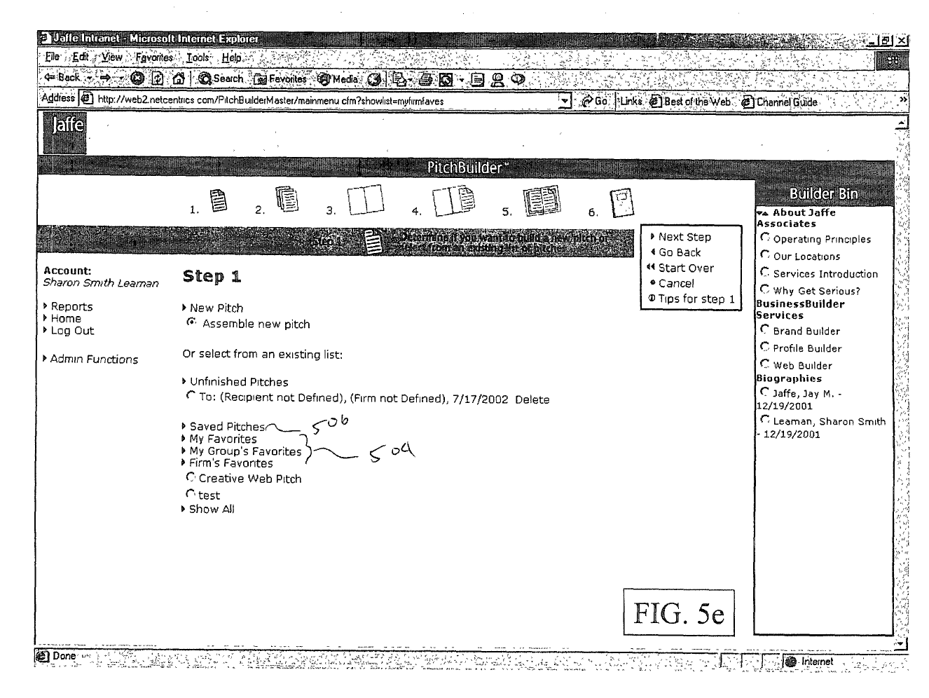

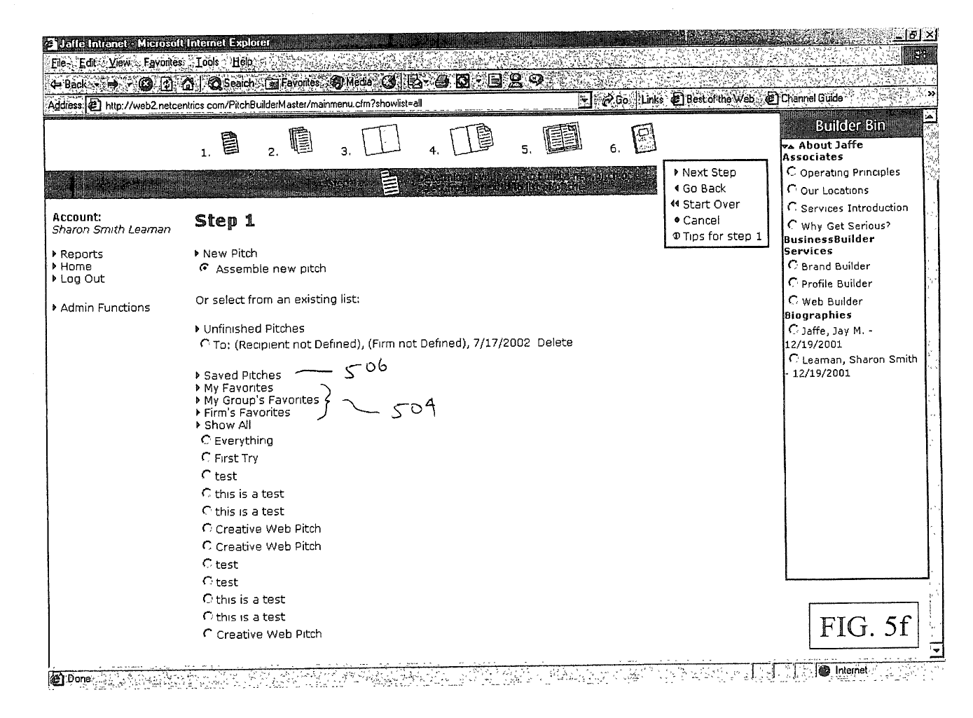

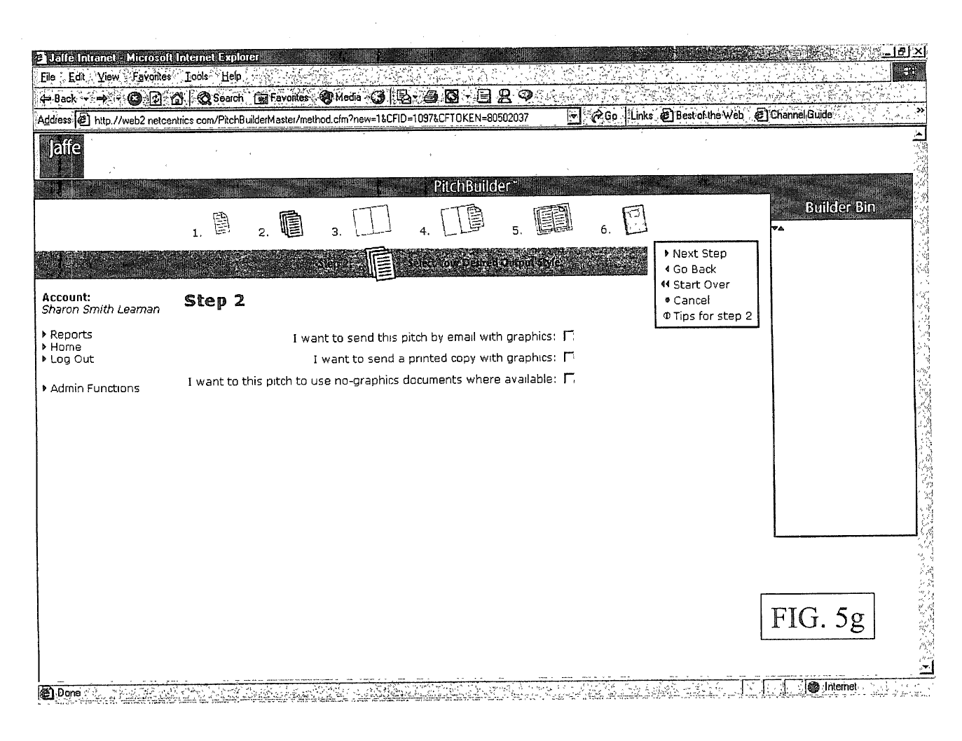

The process begins at START and proceeds to step 300 where a user enters the appropriate user indicia queried by the system. As shown in FIG. 4a which depicts a sample screen display of step 300, the user is prompted to enter a name in data field 402 and an associated password in data field 404 to gain entry to the system 100. Upon validation of the user name and password in step 302, the method proceeds to step 304 where the system 100 retrieves the user's account information in accordance with a correlated access level, otherwise the process loops back to step 300. Exemplary account information is shown in the sample display of FIG. 5a which corresponds to step 304, the user access level determines what data can be accessed/edited as shown in the display. For example, a NEW BROCHURE area 502 is provided with radio buttons 508 to allow the user to make a new brochure, a FAVORITES area 504 is provided to facilitate access to commonly utilized brochures through hyperlinks 510 also, personal favorites that are governed by the user's account information, and a SAVED BROCHURES area 506 provides access to previously designated content. Typically, the user's account information for step 304 (e.g., formatting preferences and access capabilities) are stored in the administrative information database 120 depicted in FIG. 1. The formatting preferences can be defined as default values which can be updated and edited to suit a particular application. Alternatively, the formatting preferences can be based on the user's past brochure creation and editing activities within the system. In either case, the user preferences may be used as default parameters to make the process of creating a new brochure more efficient.

Alternatively, administrative maintenance can be performed on the system where no content is desired. As shown in FIG. 4b-4c, an administrative menu 405 is provided for selecting among the exemplary administrative functions shown. For example, as shown in FIG. 4c, a user having associated permissions 409 and identification indicia generally designated 408 can be added or deleted via an administrative procedure 410 of list 405, an action button 405 is provided for initiating the desired procedure 410.

Upon retrieving the user's access capabilities in step 304 as shown in FIG. 5a, the method proceeds to step 306 where the user decides whether a new brochure is to be created or an existing brochure is to be edited. If the user plans to work with a previously created existing brochure, the method proceeds from step 306 in accordance with the “existing brochure” to step 310 where the user is asked whether the existing brochure is to be edited. If editing is desired, the method proceeds from step 310 to 312. If editing is not desired, the method proceeds from step 310 to 320.

The user has the option of accessing previously created brochures which are stored as a saved pitch as shown in FIG. 5b, a user favorite 504a as shown in FIG. 5c, a group favorite as shown in FIG. 5d, an organization favorite as shown in FIG. 5e, or the user can browse all available brochures as shown in FIG. 5f. If selecting a previously designated brochure, the user can select from a list of exemplary delivery options in FIG. 5g. For example, via the interface of FIG. 5g, the user can select an output format for an e-form or tangible output which includes embedded graphics (discussed herein).

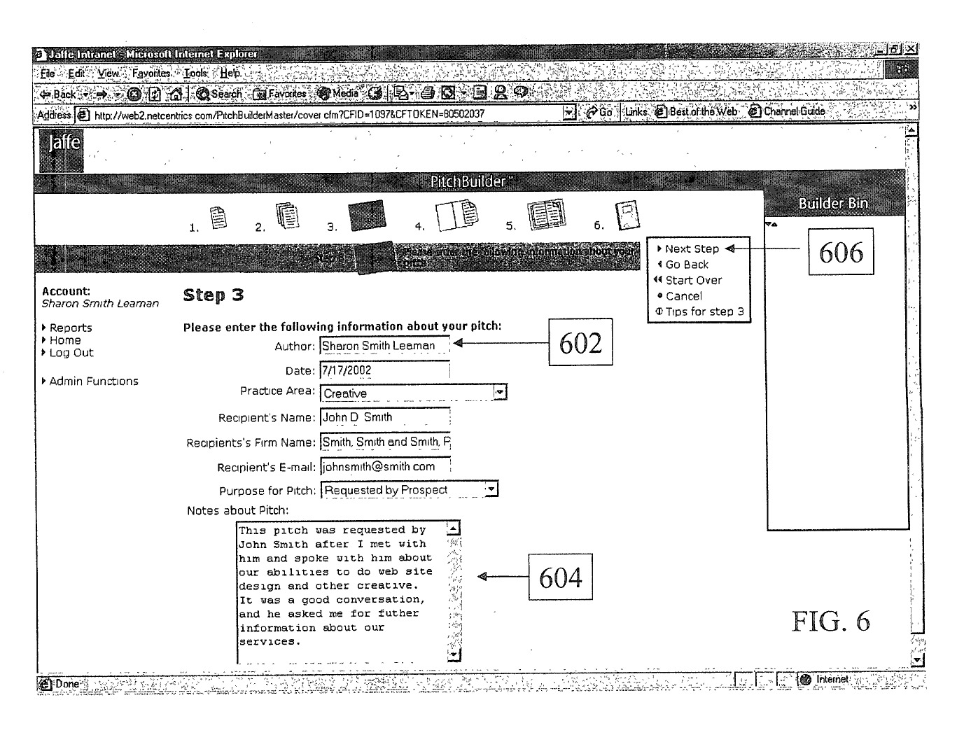

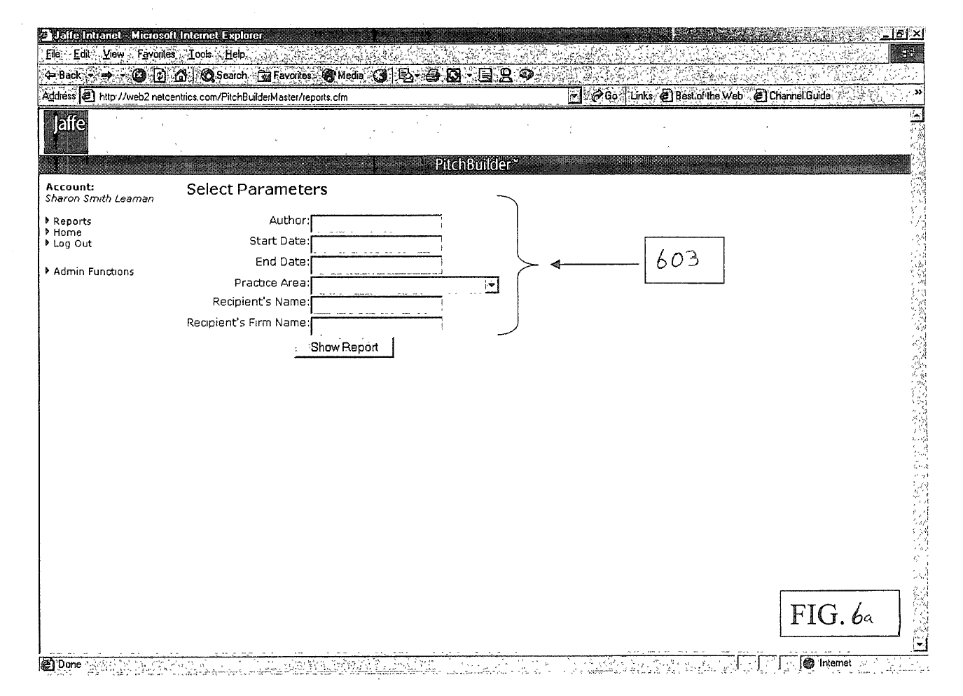

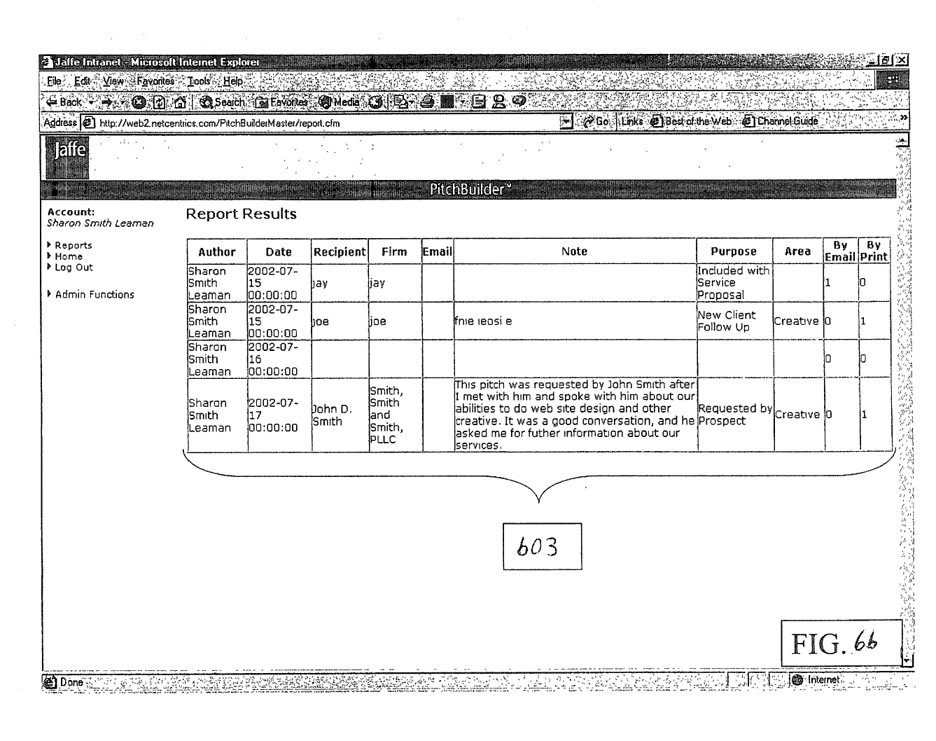

In step 308, if the user plans to create a new brochure or uses a previous brochure, the method proceeds from step 308 to step 310 where the user is presented with the exemplary screen template of FIG. 6. The exemplary template of FIG. 6 includes data fields 602 and 604 for receiving tracking data, a navigation menu 606 is provided for navigating the creation process through hyperlinks. The data fields 602 and data field 604 are provided for receiving identification information such as the name of recipient, company info, purpose of brochure and notes for use in tracking the efficacy of marketing efforts as well as system utilization. As shown in FIG. 6a, where the user is interested in learning about saved content through a query, the user can enter a customer name or creation date into the template of FIG. 6a. In this way, the user can review saved materials based on tracking data generally designated 603 (including both 602 and 604) as shown in FIG. 6b.

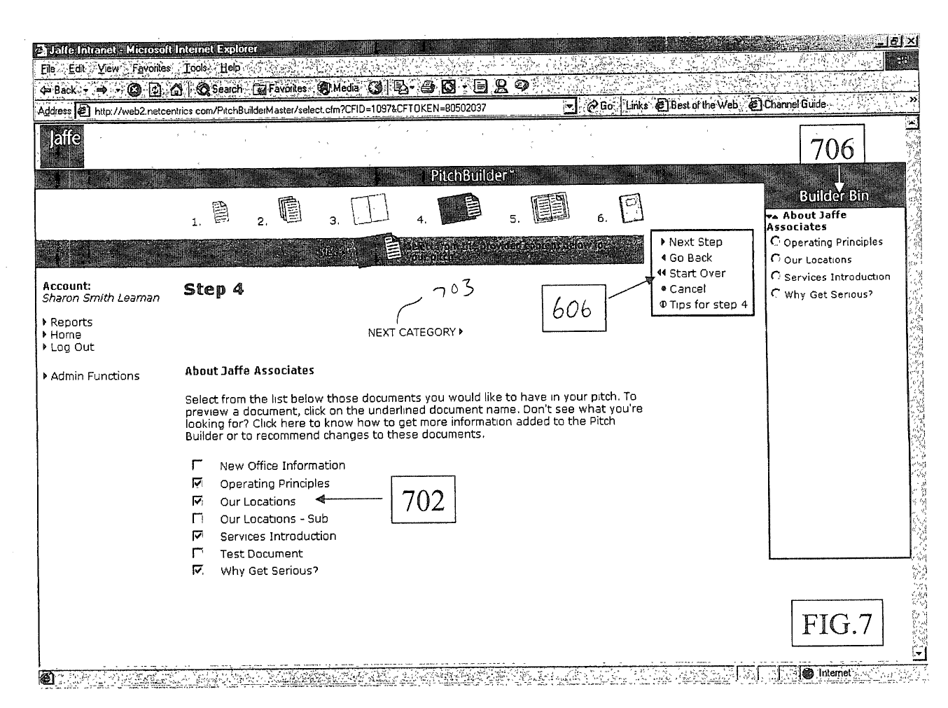

Referring again to FIG. 6, upon actuation of the next hyperlink of menu 606, the marketing interface of FIG. 7 is presented to the user. A marketing interface menu of data contains options from which to choose data for creating a marketing brochure. Typically, the content options to be presented to a user include one or more overall descriptions of the company, a location map showing the company's offices, a pictures of personnel, products and the company's building, a listing of the company's personnel, a description of the company's capabilities, descriptions of the company's products and services, contact information such as telephone numbers and mailing addresses, biographies of the employees of the company, curriculum vitae of employees of the company, pricing data, product order forms, descriptions of career options, or any other material deemed beneficial in a marketing presentation. Embodiments of the invention may have multiple versions of any of the aforementioned types of information available to different respective users, or to the same user in accordance with an access level. For example, the user may be able to choose from a very detailed description of the company and its products, or select a more top level perspective of a few sentences. Along these lines, the marketing interface includes a list of content selections, the user selects the desired selections by the checkbox or “radio button” associated with content 702. The user may proceed to additional content selections via content navigation menu 703. An ordering list or “builder bin” is shown on the display at 706, should the user desire to change the order of the selected content, the user can “drag and drop” or use navigational arrows to move the components to arrive at the desired order. A process navigation menu 606 is provided for navigating the process in accordance with the present invention.

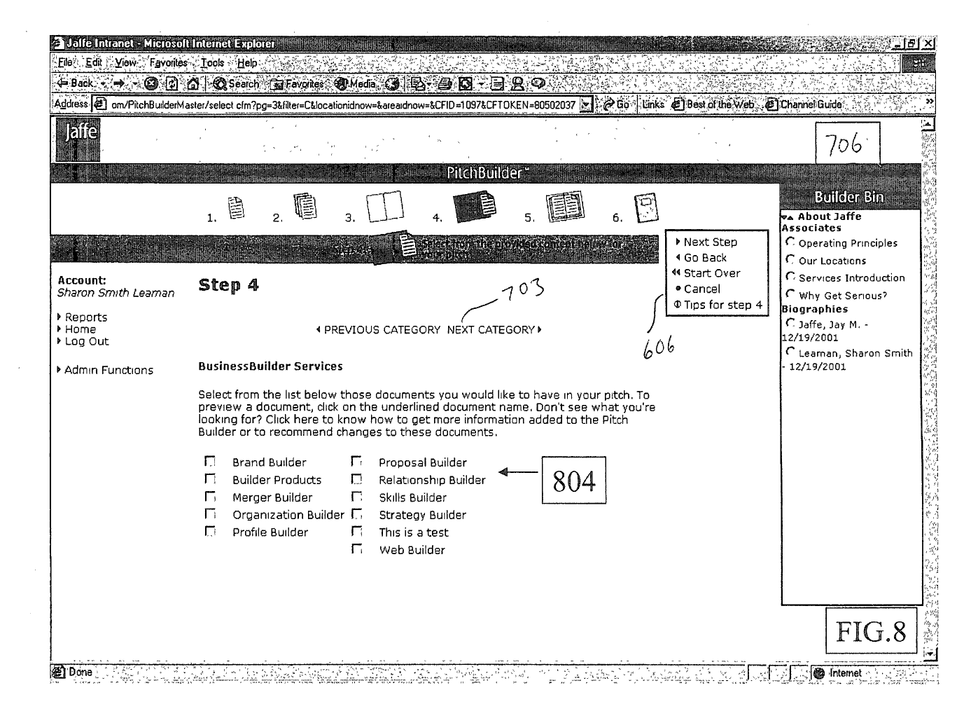

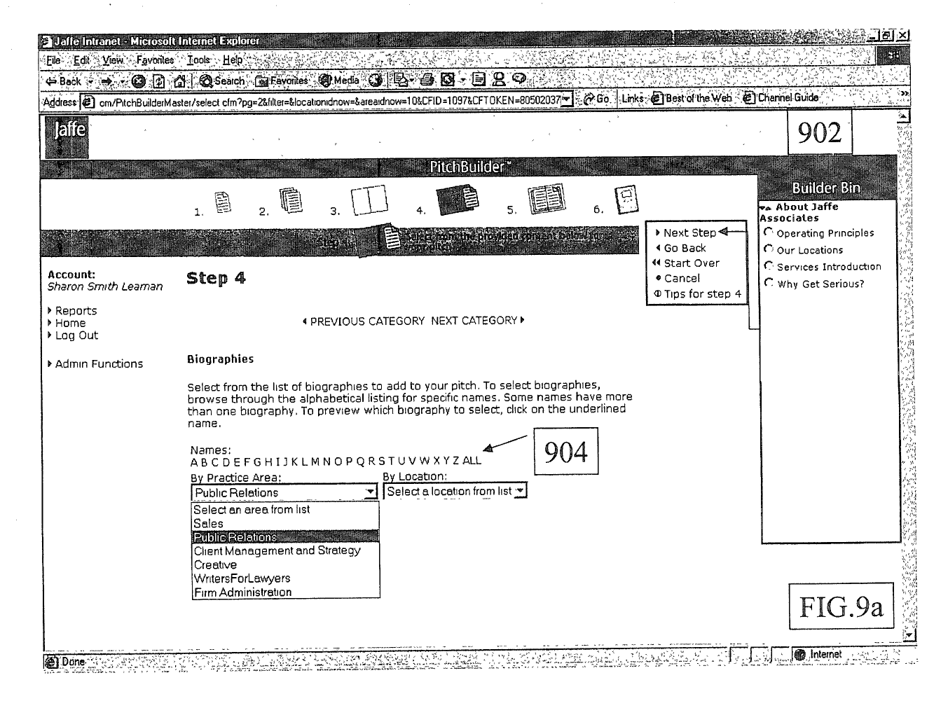

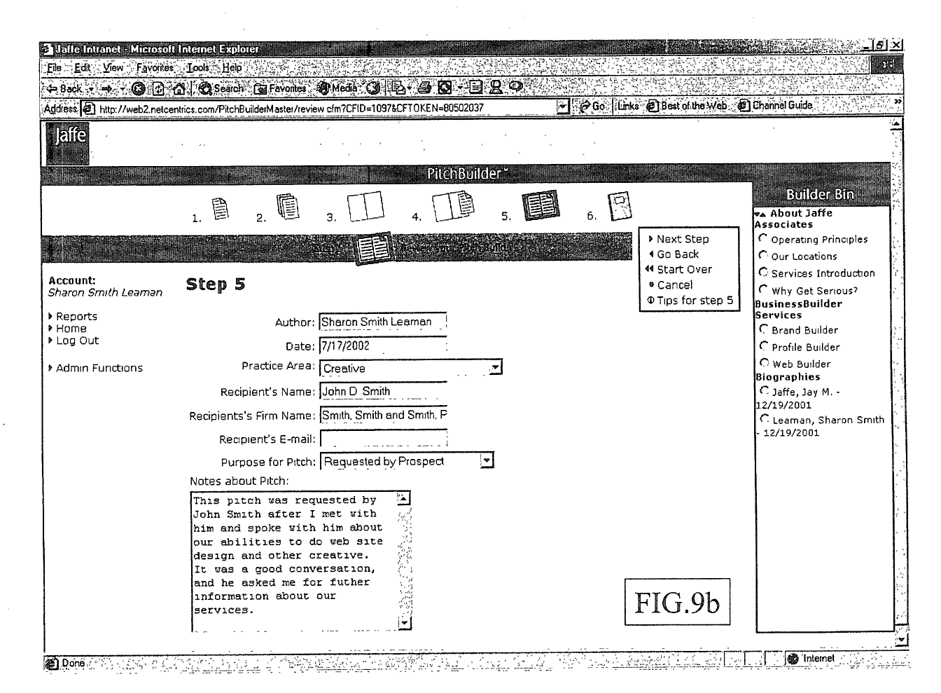

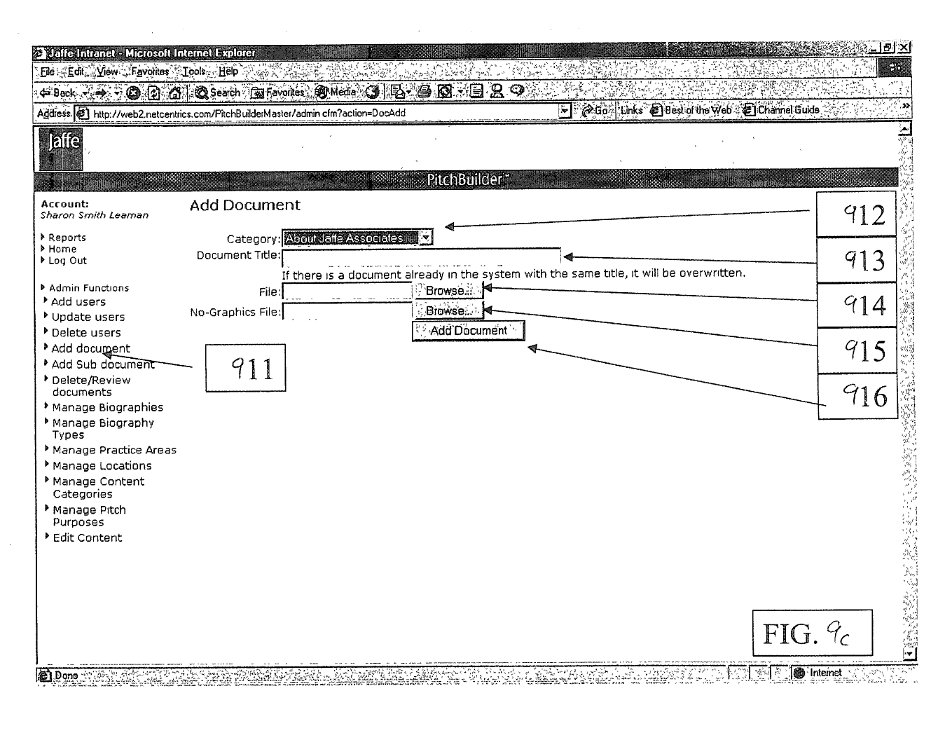

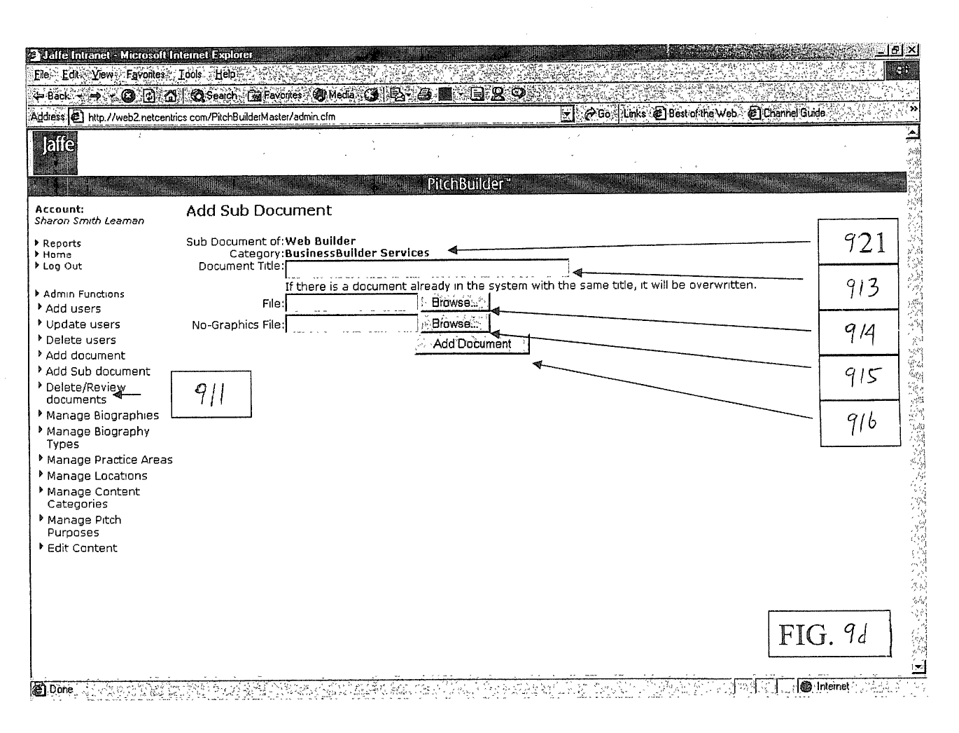

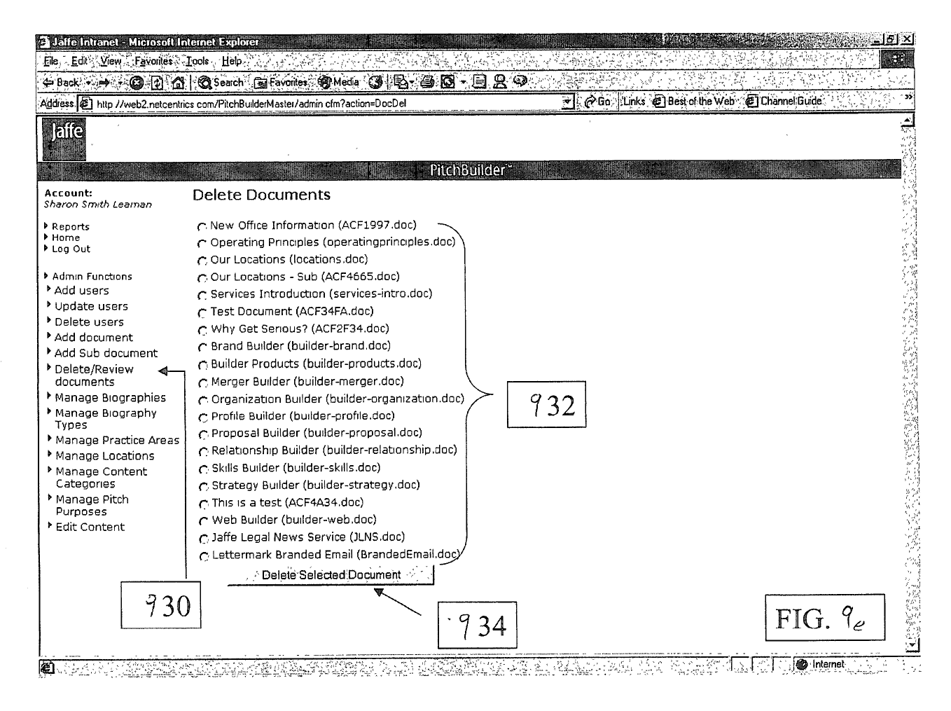

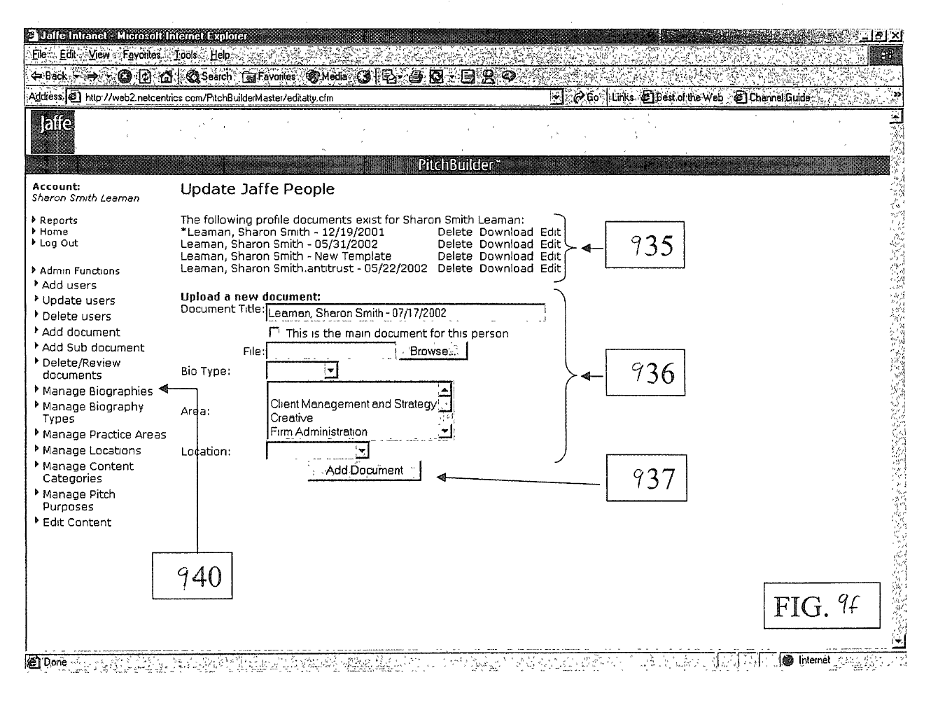

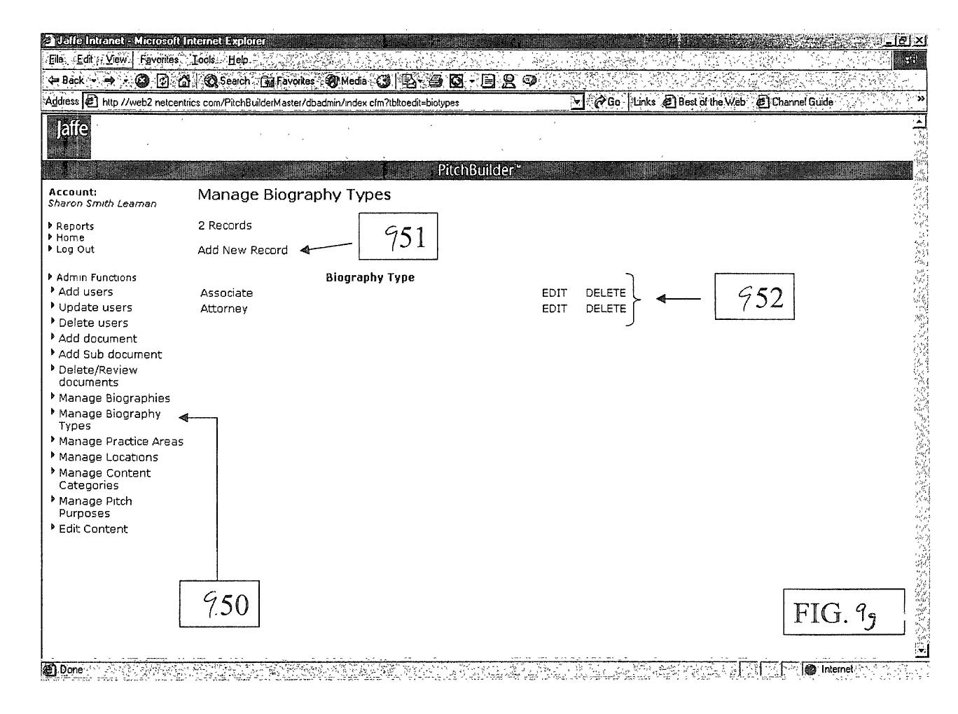

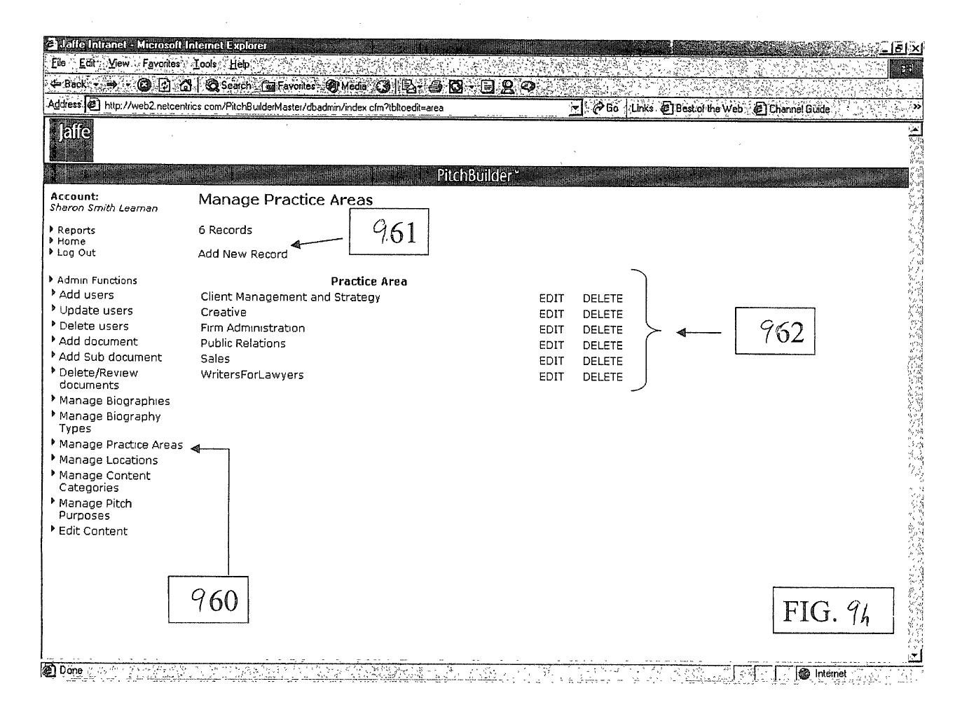

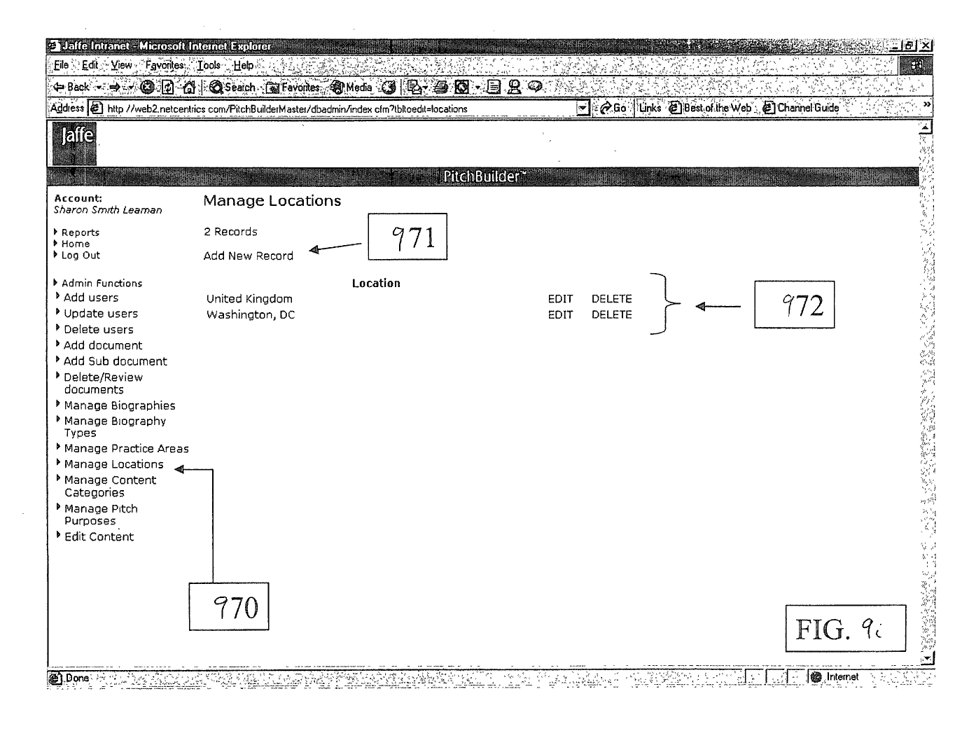

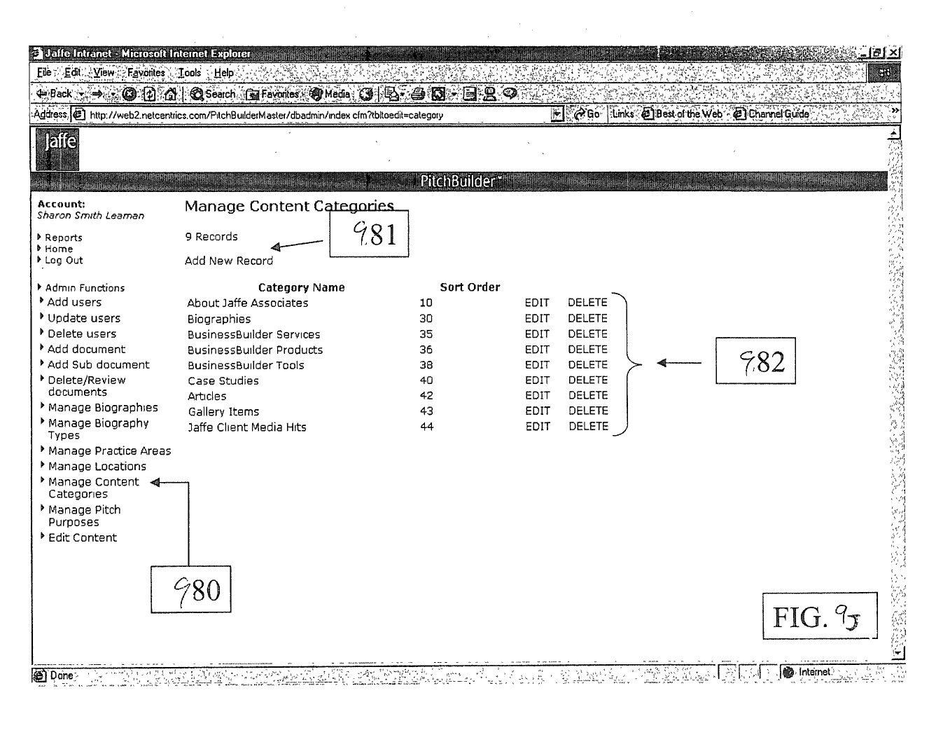

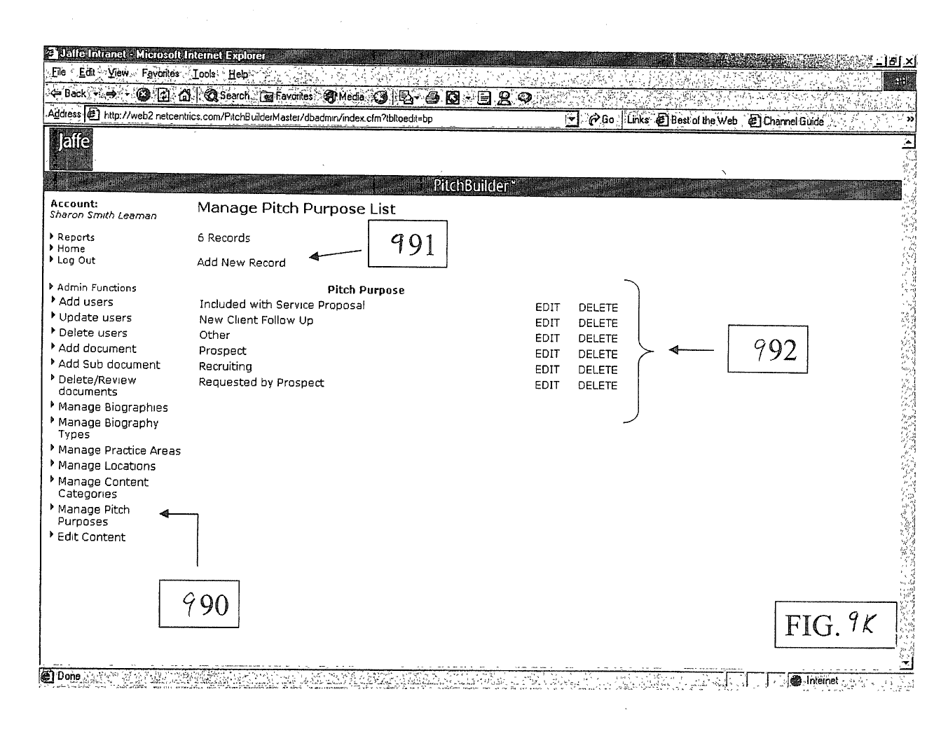

Once the user has reviewed the choices for the available brochure content in step 310, the method proceeds to 314 where the user may be presented with a sub-menu such as that shown in FIG. 8 and FIG. 9a for selecting further content or sub-components of content for incorporation in the brochure. The screen display of FIG. 8 includes check boxes 804 for further selection of content, ordering list 706 for changing the sequence of selected content. As in other screen displays, a process navigation menu 606 is provided, content navigation menu 703 is likewise provided. FIG. 9b shows an exemplary screen display for revising tracking information prior to proceeding.

At step 314, if the user desires to make content option selections the method proceeds to step 316 and the selected content materials are pulled from memory for assimilating into the brochure in the desired manner. The method then proceeds back to the step 310 for reviewing further menu options for selecting content. Once all the content selections have been made and there are no further user selections to be made regarding the content options, the method proceeds in accordance with the “no further content selections” branch from step 314 to step 318.

In step 318 the user is given the option of editing the brochure content materials. The editing step may entail reordering the order of the various brochure content, revising the text, arranging or embedding the graphics (e.g., figures or pictures), or any other like type of wordsmithing or content revision deemed appropriate to make the brochure more informative or presentable. In step 318, the user may move the materials around and place figures at various points in the brochure to enhance and tailor the presentation and effectiveness of the marketing brochure. In addition, depending upon the user's access capabilities granted from step 304, the user may be authorized to revise some of the narrative descriptions, the pricing data, or other information included in the marketing brochure.

As shown in FIG. 9c, the user can choose to supplement content by uploading new materials to the content storage database 124. For example, the user can choose an option 911 which presents the upload interface of FIG. 9c. The user is then prompted to provide a content category 912, title of the content 913, location of the content 914, providing an alternative version location 915, and submits the new content via action button 916. Similarly, the user may designate a sub-document to a content category 921 in the same manner as shown in FIG. 9d.

In order to delete content from the system 100, the user can access the menu of FIG. 9e for performing a delete function 930. An exemplary list of available content is shown as 932, the user can select content via radio buttons, and initiate the delete function through action button 934.

FIGS. 9f-9k shows a further example of an edit feature in accordance with the present invention. A user can manage (e.g., update or add) content of the system 940. The authorized user will select the content to be managed, and can download, delete or edit the biography from the GUI as shown at 935. The authorized user may also define new content such as a “biography” by way of data fields 936, defining it by title, type (see FIG. 9g), location (FIG. 9k) and area (FIG. 9h). The authorized user submits the updated information to the system 100 through action button 937.

FIG. 9g shows an exemplary interface for facilitating, by authorized users, the definition of the types of biography categories individual biographies will be assigned to for search purposes 950. An authorized user can add 951, edit or delete biography types 952). Likewise, FIG. 9h shows an exemplary interface for facilitating authorized users to define the types of areas that a biography can be assigned to for search purposes 960. An authorized user can add 961, edit or delete practice area types 962. FIG. 9i shows an exemplary interface for facilitating authorized users to define the types of locations that a biography can be assign to for search purposes 970. An authorized user can add 971, edit or delete location types 972. These feature correlate with the features as shown on FIG. 9a.

FIG. 9j shows an exemplary interface for facilitating authorized users to define the types of content categories that documents in the system can be assign to for organization purposes 980. An authorized user can add 981, edit or delete content category types 982. This feature correlates with the features as shown on FIGS. 7-9a.

FIG. 9k shows an exemplary interface for facilitating authorized users to define the types of purposes for a brochure for the reporting and tracking feature 990. An authorized user can add 991, edit or delete content category types 992. This feature correlates with the features as shown on FIGS. 6 and 4b-4c.

Once the editing of the marketing brochure has been completed in step 318, the method proceeds to step 320 to perform a file format translation on the brochure file. In step 322 the various portions of the brochure are translated into one file format, for example, Adobe Acrobat™ PDF format. In accordance with alternative embodiments, other formats may be used as well (e.g., GIF, HTML, XML, or like file formats or electronic protocols). In many instances, it is advantageous, for the purposes of printing, emailing and file storage, to translate the entire brochure in a single format. However, alternative embodiments of the present invention can create a brochure as a compilation of various pieces having different file formats (e.g., ASCII text with embedded graphics in PDF), in which case the step 322 is not performed.

Upon completion of the brochure file translation in step 320, the method proceeds to step 320 for a print preview of the final brochure. Typically, in accordance with embodiments of the present invention, the print preview is performed in a WYSIWYG (what you see is what you get) format. In this way, the user is able to review the marketing brochure without wasting the resources required to print out copies for review or the time it takes for such printing. Once the marketing brochure has been reviewed in step 320, the method proceeds to step 324 where the user is queried as to whether further editing is desired. If the user wants to further edit the format of the marketing brochure, the method returns to step 308. If no further editing is desired, the method proceeds from step 324 to step 326.

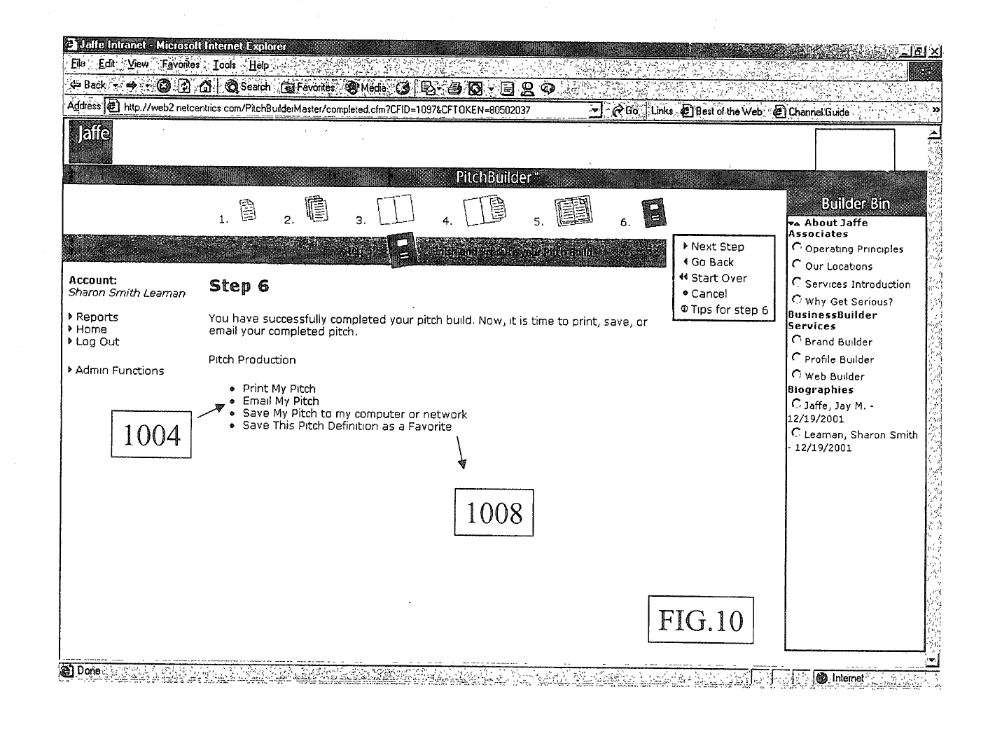

In step 326, the user decides whether to present the selected content in a tangible or e-form as shown at area 1004 in the screen display of FIG. 10. FIG. 10 provides a data field 1008 for naming the created brochure as a favorite and delivery options 1004. The tangible form may include a printed material or on a recorded medium such as a CD-ROM, DVD, and the like. For creating a tangible form, the method proceeds to step 334 where the user is requested to enter print options, or configure a write process of a recordable medium drive for creating a recorded medium. Upon deciding on the tangible options (e.g., quantity to be created, device to use, etc), the method proceeds to step 334 for creating the tangible form. If, instead of creating a tangible form of the marketing brochure, the user decides in step 326 to send the brochure in E-form, the method proceeds from step 326 to step 328 where the user is prompted to enter the options for sending the e-form. For example, where the E-form is email, the user inputs (e.g., addressees, parties to receive copies or blind copies, disclaimers, return address or contact information, or the like). Where the E-form is a audio-visual presentation, (e.g., multimedia, video, audio, or to be uploaded to as a website) the user may enter a peripheral or computer address, such as an Internet protocol (IP) address for receiving the content such as during a video conference. Upon entering the E-form options, the method proceeds from step 328 to step 330 and the brochure is sent in E-form as designated.

Upon completion of either step 330 or step 334, the method proceeds to step 340 and the brochure is saved to a computer memory such as the content storage database 124 of FIG. 1, a floppy disc or other storage device. Once the brochure has been saved, the method proceeds to END. Those skilled in the art will recognize that the above sequence of steps is exemplary only and that the inventive subject matter can be implemented in an altogether different sequence as described above.

Obviously, readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as magnetic or optical disk, or a radio frequency or audio frequency carrier wave.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

We claim:

1 A method of designating selected materials of a collection of content for presentation to a target entity, comprising steps of:
prompting a user to input identification indicia associated with the user, the identification indicia corresponding to an access level of a plurality of access levels;
granting the user access at the access level in response to the identification indicia input by the user in the prompting step;
providing a marketing interface to the user for selecting a plurality of content options made available to the user in accordance with the access level;
designating the selected materials targeted for the target entity by selecting the content options of the marketing interface;
providing the user with an option for formatting the appearance of the selected materials; and
producing the selected materials of the collection of content for presentation to the target entity.

2. The method according to claim 1, further comprising a step of:
prompting the user for target entity information for use in identifying the selected materials.

3. The method according to claim 1, further comprising a step of:
prompting the user for comments regarding the selected material.

4. The method of claim 1, further comprising a step of:
editing the selected materials where the user access level permits selection.

5. The method according to claim 1, wherein the collection of content includes audio data.

6. The method according to claim 1, wherein the collection of content includes video data.

7. The method according to claim 1, wherein the collection includes Microsoft Excel® data;

8. The method according to claim 1, wherein the collection includes Microsoft Powerpoint® data;

9. The method according to claim 1, further comprising a step of:
selecting one or more niche market content options provided to the user by the marketing interface for inclusion into the collection of content.

10. The method according to claim 1, further comprising a step of:
arranging the one or more of the niche market content options into a desired sequence for the presentation.

11. The method according to claim 1, further comprising:
translating the selected materials into a single electronic format.

12. The method according to claim 10, where each niche market selected includes a sub-menu for designating further information pertaining to the niche market.

13. The method of claim 1, further comprising a step of:
printing the content for presentation to the target entity.

14. The method of claim 1, further comprising a step of:
storing the presentation of selected materials and associated identification information for tracking purposes.

15. The method according to claim 4, wherein the editing steps includes uploading new content.

16. An electronic system for designating selected materials of a collection of content for presentation to a target entity, comprising:
means for storing the collection of content;
means for prompting a user to an access level of a plurality of access levels, the user being granted access to the content at the access level;
interface means for selecting content options in accordance with the access level to designate the selected materials targeted for the target entity by selecting the content options and for providing the user with options for formatting the selected materials; and
output means for producing the selected materials of the collection of content for presentation to the target entity.

17. The electronic system of claim 16, wherein the output means includes a telecommunication link for providing the selected materials to the target entity.

18. The electronic system of claim 16, wherein the telecommunication link is wireless.

19. The electronic system of claim 16, wherein the output means is a printing device.

20. The electronic system of claim 16, wherein the means for storing comprises a remotely accessible database such as a network server or WAN (Wide Area Network).

21. A computer readable carrier including computer program instructions that cause a computer to implement a method of designating selected materials of a collection of content for presentation to a target entity, the method comprising steps of:
prompting a user in input identification indicia associated with the user, the identification indicia corresponding to an access level of a plurality of access levels;
granting the user access at the access level in response to the identification indicia input by the user in the prompting step;
providing a marketing interface to the user for selecting a plurality of content options made available to the user in accordance with the access level;
designating the selected materials targeted for the target entity by selecting the content options of the marketing interface;
providing the user with an option for formatting the appearance of the selected materials; and
producing the selected materials of the collection of content for presentation to the target entity.
